(19) United States
(12) Patent Application Publication
(10) Pub. No.: US 2024/0325960 A1
(43) Pub. Date: Oct. 3, 2024

(54) Air Filtration Device And Method Of Use

(71) Applicants: Bulmaro Ascencio, Merced, CA (US); Aurora Ascencio, Merced, CA (US)

(72) Inventors: Bulmaro Ascencio, Merced, CA (US); Aurora Ascencio, Merced, CA (US)

(21) Appl. No.: 18/128,683

(22) Filed: Mar. 30, 2023

(51) Int. Cl. B01D 46/52; B60H 3/06; F24F 8/108; F24F 13/08; F24F 13/28

(52) U.S. Cl. CPC B01D 46/521; B60H 3/0608; F24F 8/108; F24F 13/085; F24F 13/28; B01D 2265/06; B01D 2275/205; B01D 2279/40; B01D 2279/50; B60H 2003/065

(57) ABSTRACT

An air filtration device for filtering air exiting an outlet vent of a heating, ventilation, and air conditioning (HVAC) system includes a filter assembly that is sized and shaped complementarily to a cross-sectional profile of the HVAC system. The filter assembly is selectively insertable into the duct of the HVAC system behind a vent cover that is attached to the duct. The filter assembly comprises a plurality of ribs to which a filter is attached. The filter has a perimeter that is complementary to a cross-sectional profile of the duct so that the filter frictionally attaches to the duct. The filter removes contaminants from air that exits from the vent cover.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to air filters and more particularly pertains to a new air filter for filtering air exiting an outlet vent of a heating, ventilation, and air conditioning (HVAC) system. The present invention discloses an air filter comprising a filter assembly that is insertable into and frictionally attachable to a duct of the HVAC system.

### (2) Description of Related Art Including Information Disclosed Under 37 CFR 1.97 and 1.98

The prior art relates to air filters, which may comprise filters attachable to register covers, either on their exposed or unexposed faces. Related prior art includes register covers having integral or selectively attachable filters. What is lacking in the prior art is an air filter comprising a filter assembly that is insertable into and frictionally attachable to a duct of a heating, ventilation, and air conditioning (HVAC) system, proximate to an outlet vent of the HVAC system, and which is not attached to a register cover.

### BRIEF SUMMARY OF THE INVENTION

An embodiment of the disclosure meets the needs presented above by generally comprising a filter assembly that is sized and shaped complementarily to a cross-sectional profile of a duct of a heating, ventilation, and air conditioning (HVAC) system. The filter assembly is configured for selective insertion into the duct of the HVAC system behind a vent cover that is attached to the duct. The filter assembly comprises a plurality of ribs to which a filter is attached. The filter has a perimeter that is complementary to the cross-sectional profile of the duct. The filter is configured to frictionally attach to the duct and to remove contaminants from air that exits from the vent cover.

Another embodiment of the disclosure includes a method of providing filtered air to a substantially airtight space. Provision steps of the method are providing an HVAC system in fluidic communication with a substantially airtight space and providing an air filtration device, according to the disclosure above. Installation steps of the method are detaching the vent cover, inserting the filter assembly into the duct, and reattaching the vent cover. A use step of the method is actuating the HVAC system.

Yet another embodiment of the disclosure includes an air filtration system comprising an HVAC system, which is in fluidic communication with a substantially airtight space, and an air filtration device, according to the disclosure above. A filter assembly of the filter assembly is inserted into a duct of the HVAC system behind a vent cover attached to the duct so that a filter of the air filtration device is frictionally attached to the duct. The filter is configured to remove contaminants from air that exits from the vent cover.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front exploded in-use view of an air filtration device according to an embodiment of the disclosure.

FIG. 2 is a rear exploded in-use view of an embodiment of the disclosure.

FIG. 3 is a side detail view of an embodiment of the disclosure.

FIG. 4 is a front view of an embodiment of the disclosure.

FIG. 5 is an in-use view of an embodiment of the disclosure.

FIG. 6 is an in-use view of an embodiment of the disclosure.

FIG. 7 is a flow diagram for a method utilizing an embodiment of the disclosure.

### DETAILED DESCRIPTION OF THE INVENTION

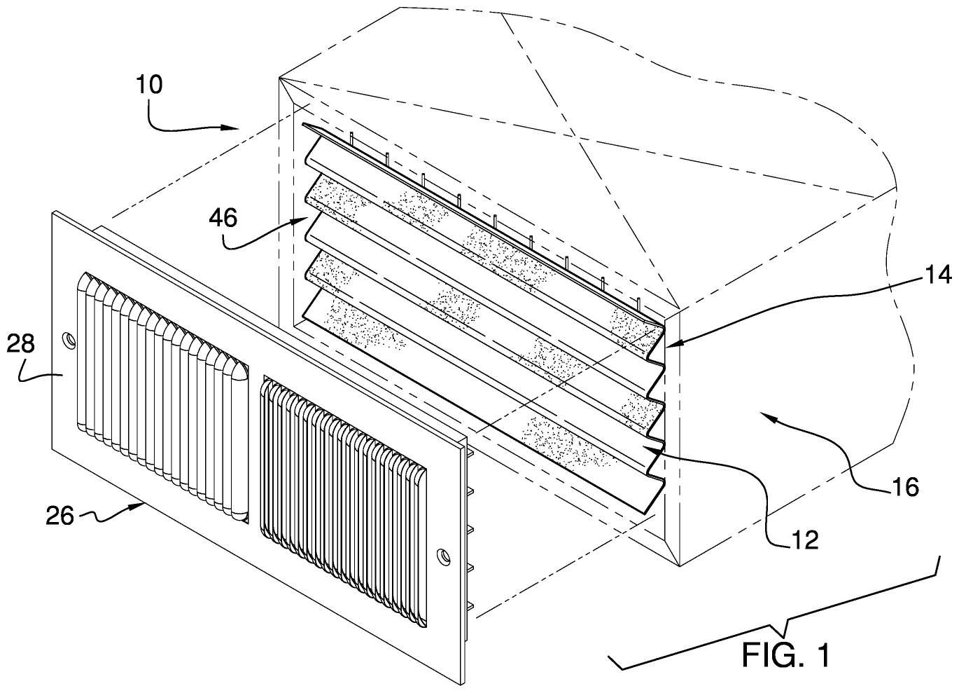

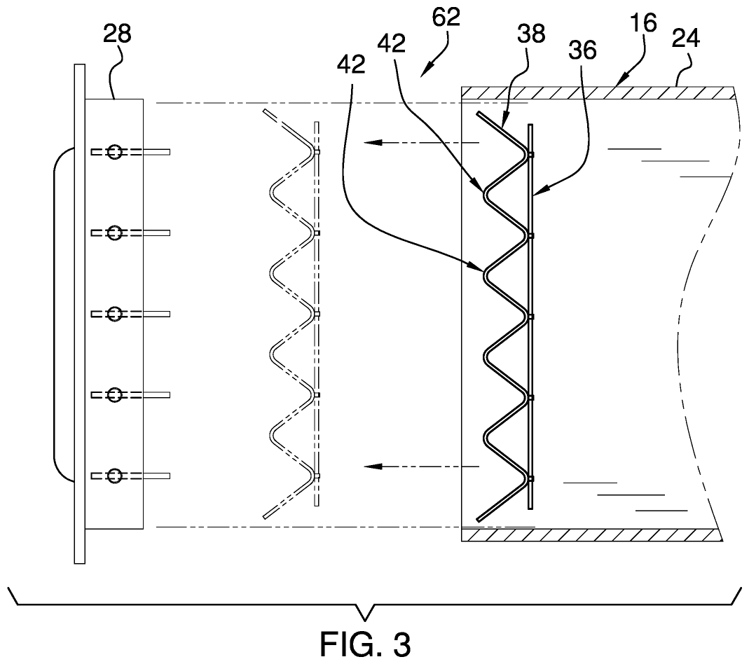

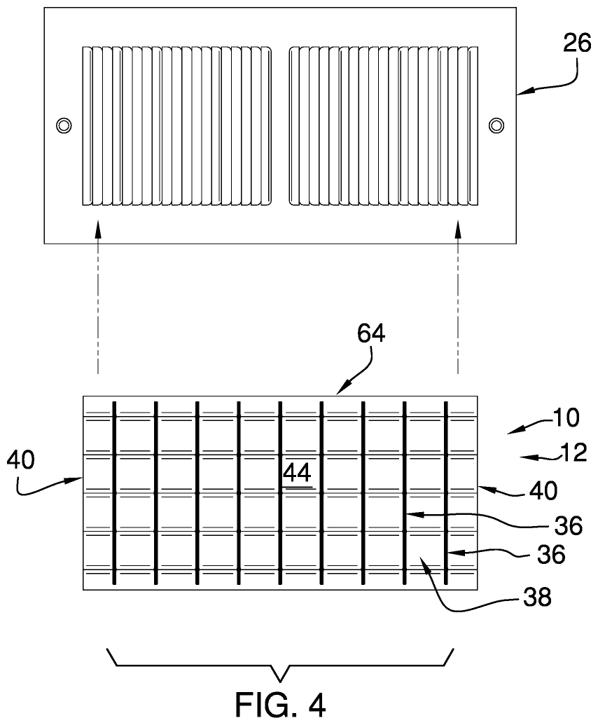

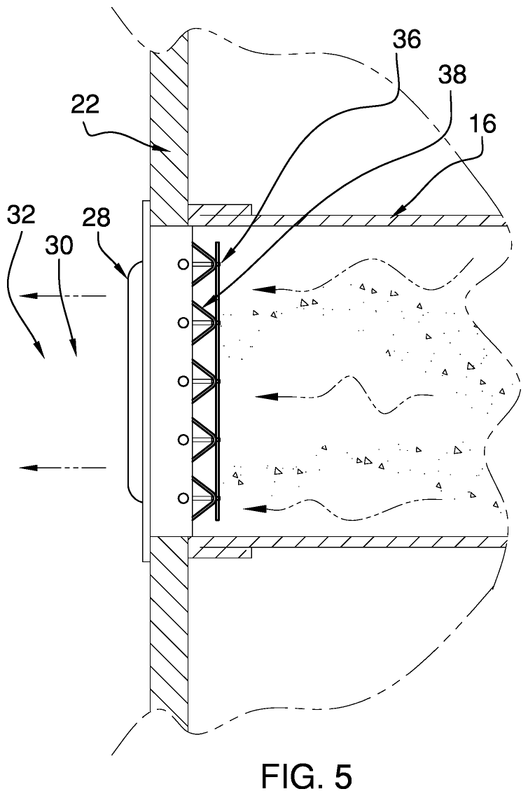

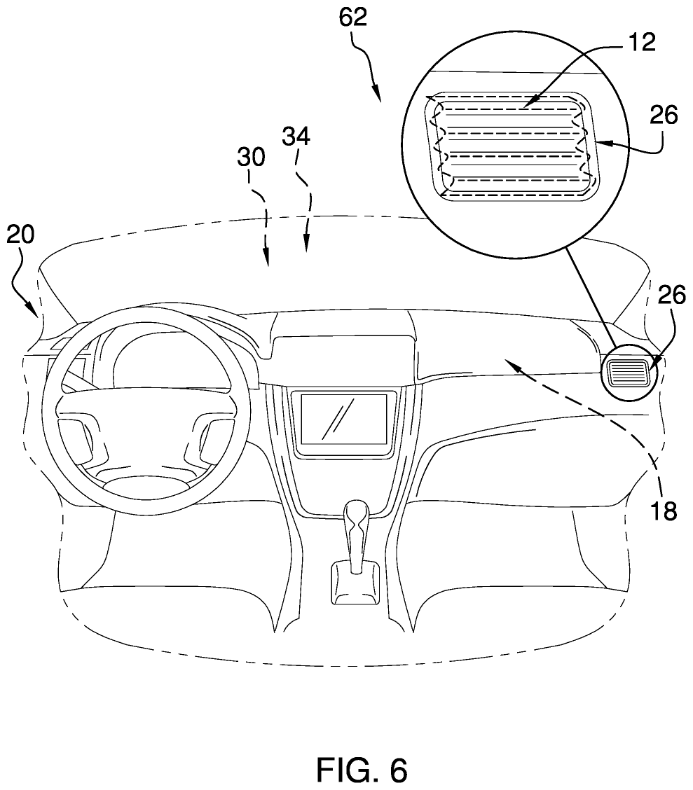

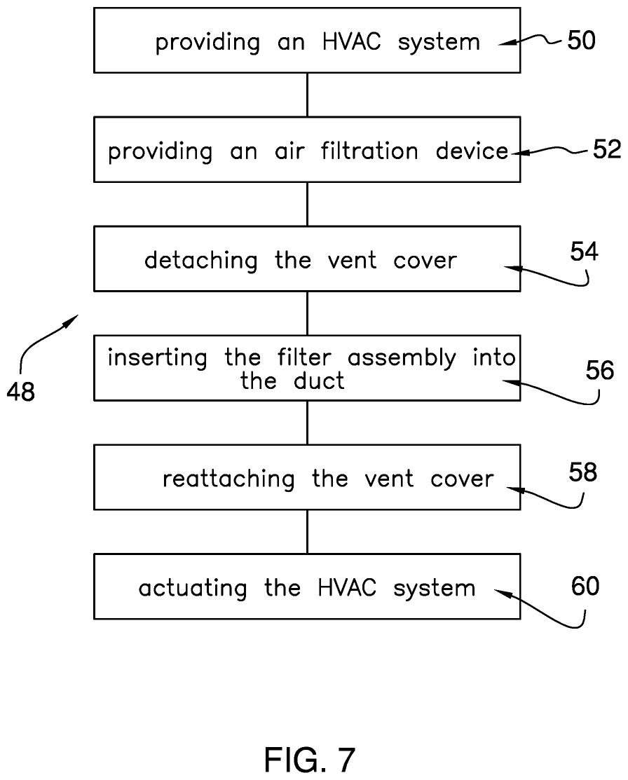

With reference now to the drawings, and in particular to FIGS. 1 through 7 thereof, a new air filter embodying the principles and concepts of an embodiment of the disclosure and generally designated by the reference numeral 10 will be described.

As best illustrated in FIGS. 1 through 7, the air filtration device 10 generally comprises a filter assembly 12 that is sized and shaped complementarily to a cross-sectional profile 14 of a duct 16 of a heating, ventilation, and air conditioning (HVAC) system 18, such as may be integral to a vehicle 20 or a building 22. Duct 16 in the context of this disclosure should be interpreted to include ducts 16 that is used in buildings 22, such as homes, offices, or the like, which may be rectangular, as shown in FIGS. 1, 3, and 5, and round or the like, as well as register boxes 24, which may be attached to the duct 16, with the filter assembly 12 being sized and shaped complementarily to a cross-section of the register box 24. Duct 16 in the context of this disclosure also includes a duct 16 integral to an HVAC system 18 of a vehicle 20, such as a passenger car, pickup, truck, tractor, heavy equipment, or the like. The filter assembly 12 is configured for selective insertion into the duct 16 of the HVAC system 18 behind a vent cover 26 that is attached to the duct 16, or, in the case of the duct 16 comprising a register box 24, behind a register cover 28 removably attachable to the register box.

Such HVAC systems 18 often incorporate filtration means that are positioned on intake ducts or proximate to blowers of the HVAC systems 18. These filtration means filter out contaminants from air entering the intake ducts and from air exiting the blowers, respectively. However, any contaminants which pass through these filtration means, or which are picked up by the air after it passes through the filtration means, are eventually introduced into substantially airtight spaces 30, such as rooms 32 of buildings 22 and passenger compartments 34 of vehicles 20, where they can be inhaled by occupants.

The filter assembly 12 comprises a plurality of ribs 36 to which a filter 38 is attached. The filter 38 has a perimeter 64 that is complementary to the cross-sectional profile 14 of the duct 16. The filter 38 is configured to frictionally attach to the duct 16 and to remove contaminants from air that exits from the vent cover 26. The present invention also anticipates the plurality of ribs 36 being configured to frictionally attach to the duct 16, rather than the filter 38.

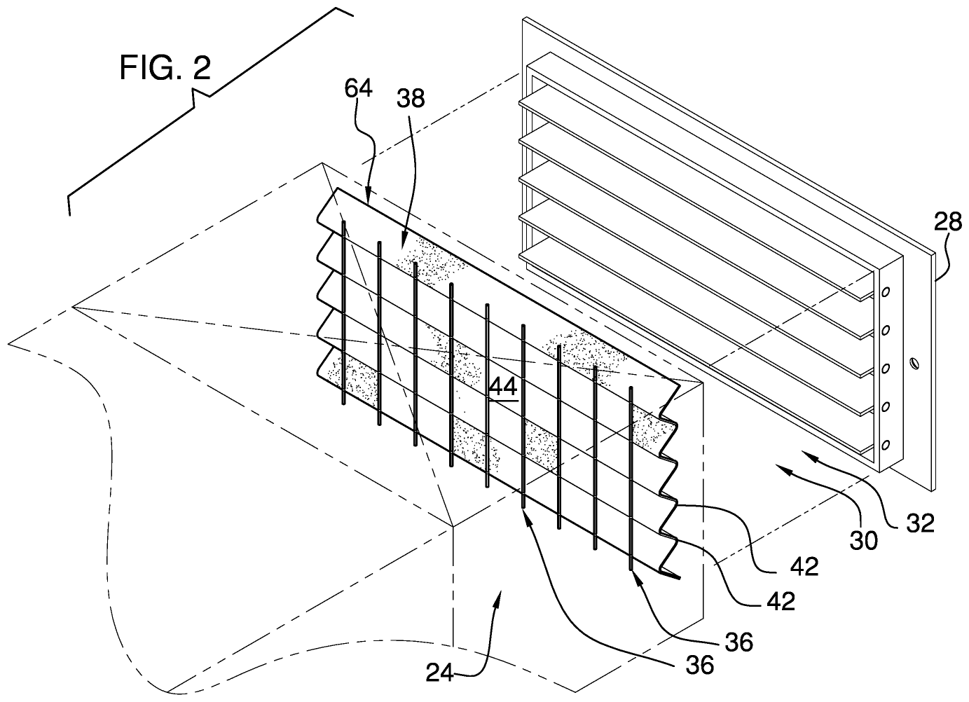

The ribs 36 of the plurality of ribs 36 may be substantially parallel, as shown in FIG. 2, although the present invention also anticipates the ribs 36 being nonparallel. The present invention also anticipates the ribs 36 being crossed and mutually attached so as to form a grid. The ribs 36 may be substantially evenly spaced, as shown in FIG. 2, or unevenly spaced. For example, ribs 36 positioned proximate to opposed ends 40 of the filter 38 may be positioned close together to provide enhanced structural support to the filter 38. The ribs 36 comprise plastic, metal, wood, or the like.

The filter 38 comprises paper, cotton, polyurethane foam, or the like. As shown in FIGS. 1-3, a plurality of pleats 42 is positioned in the filter 38 so that a surface area 44 of the filter 38 is greater than a cross-sectional area 46 of the duct 16. The surface area 44 of the filter 38 being greater than the cross-sectional area 46 of the duct 16 reduces back pressure created by placement of the filter assembly 12 in the duct 16 and allows for adequate airflow. As shown in FIG. 2, the ribs 36 are substantially perpendicular to the pleats 42, thereby supporting the pleating of the filter 38.

The present invention also anticipates an air filtration system 62, which comprises HVAC system 18, which is in fluidic communication with a substantially airtight space 30, and an air filtration device 10, according to the specification above. A filter assembly 12 of the air filtration device 10 is inserted into a duct 16 of the HVAC system 18, behind a vent cover 26 that attached to the duct 16, so that a filter 38 of the filter assembly 12 is frictionally attached to the duct 16. The filter 38 is configured to remove contaminants from air that exits from the vent cover 26.

In use, the air filtration device 10 enables a method of providing filtered air to a substantially airtight space 48. The method 48 comprises a first provision step 50, which entails providing an HVAC system 18 in fluidic communication with a substantially airtight space 30. A second provision step 52 of the method 48 is providing an air filtration device 10, according to the specification above. A first installation step 54 of the method 48 is detaching a vent cover 26 attached to the duct 16. A second installation step 56 of the method 48 is inserting the filter assembly 12 into the duct 16. A third installation step 58 of the method 48 is reattaching the vent cover 26. A use step 60 of the method 48 is actuating the HVAC system 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An air filtration device comprising a filter assembly sized and shaped complementarily to a cross-sectional profile of a duct of a heating, ventilation, and air conditioning (HVAC) system, wherein the filter assembly is configured for selective insertion into the duct of the HVAC system behind a vent cover attached to the duct, the filter assembly comprising:
a plurality of ribs; and
a filter attached to the plurality of ribs and having a perimeter complementary to the cross-sectional profile of the duct, wherein the filter is configured for frictionally attaching to the duct and for removing contaminants from air exiting from the vent cover.

2. The air filtration device of claim 1, wherein the ribs of the plurality of ribs are substantially parallel.

3. The air filtration device of claim 1, wherein the ribs of the plurality of ribs are substantially evenly spaced.

4. The air filtration device of claim 1, wherein the ribs of the plurality of ribs comprise plastic, metal, or wood.

5. The air filtration device of claim 1, wherein the filter comprise paper, cotton, or polyurethane foam.

6. The air filtration device of claim 1, further including a plurality of pleats positioned in the filter, such that a surface area of the filter is greater than a cross-sectional area of the duct.

7. The air filtration device of claim 6, wherein the ribs of the plurality of ribs are substantially perpendicular to the pleats of the plurality of pleats.

8. The air filtration device of claim 1, further including:
the ribs of the plurality of ribs being substantially parallel, the ribs of the plurality of ribs being substantially evenly spaced, the ribs of the plurality of ribs comprising plastic, metal, or wood; and
the filter comprising paper, cotton, or polyurethane foam; and
a plurality of pleats positioned in the filter, such that a surface area of the filter is greater than a cross-sectional area of the duct, the ribs of the plurality of ribs being substantially perpendicular to the pleats of the plurality of pleats.

9. A method of providing filtered air to a substantially airtight space comprising the steps of:
providing a heating, ventilation, and air conditioning (HVAC) system in fluidic communication with a substantially airtight space;
providing an air filtration device comprising a filter assembly sized and shaped complementarily to a cross-sectional profile of a duct of the HVAC system, wherein the filter assembly is configured for selective insertion into the duct of the HVAC system behind a vent cover attached to the duct, the filter assembly comprising:
a plurality of ribs, and
a filter attached to the plurality of ribs and having a perimeter complementary to the cross-sectional profile of the duct, wherein the filter is configured for frictionally attaching to the duct and for removing contaminants from air exiting from the vent cover;
detaching the vent cover;
inserting the filter assembly into the duct;
reattaching the vent cover; and
actuating the HVAC system.

10. The method of claim 10, further including:
the ribs of the plurality of ribs being substantially parallel, the ribs of the plurality of ribs being substantially evenly spaced, the ribs of the plurality of ribs comprising plastic, metal, or wood; and
the filter comprising paper, cotton, or polyurethane foam; and
a plurality of pleats positioned in the filter, such that a surface area of the filter is greater than a cross-sectional area of the duct, the ribs of the plurality of ribs being substantially perpendicular to the pleats of the plurality of pleats.

11. An air filtration system comprising:
a heating, ventilation, and air conditioning (HVAC) system in fluidic communication with a substantially airtight space; and
an air filtration device comprising a filter assembly sized and shaped complementarily to a cross-sectional profile of a duct of the HVAC system, the filter assembly being inserted into the duct of the HVAC system behind a vent cover attached to the duct, the filter assembly comprising:
a plurality of ribs, and
a filter attached to the plurality of ribs and having a perimeter complementary to the cross-sectional profile of the duct, the filter being frictionally attached to the duct, wherein the filter is configured for removing contaminants from air exiting from the vent cover.

12. The air filtration system of claim 11, wherein the ribs of the plurality of ribs are substantially parallel.

13. The air filtration system of claim 11, wherein the ribs of the plurality of ribs are substantially evenly spaced.

14. The air filtration system of claim 11, wherein the ribs of the plurality of ribs comprise plastic, metal, or wood.

15. The air filtration system of claim 11, wherein the filter comprise paper, cotton, or polyurethane foam.

16. The air filtration system of claim 11, further including a plurality of pleats positioned in the filter, such that a surface area of the filter is greater than a cross-sectional area of the duct.

17. The air filtration system of claim 16, wherein the ribs of the plurality of ribs are substantially perpendicular to the pleats of the plurality of pleats.

18. The air filtration system of claim 11, further including:
the ribs of the plurality of ribs being substantially parallel, the ribs of the plurality of ribs being substantially evenly spaced, the ribs of the plurality of ribs comprising plastic, metal, or wood; and
the filter comprising paper, cotton, or polyurethane foam; and
a plurality of pleats positioned in the filter, such that a surface area of the filter is greater than a cross-sectional area of the duct, the ribs of the plurality of ribs being substantially perpendicular to the pleats of the plurality of pleats.
